(19) United States
(12) Patent Application Publication
(10) Pub. No.: US 2023/0366401 A1
(43) Pub. Date: Nov. 16, 2023

(54) SCROLL COMPRESSOR

(71) Applicant: Samsung Electronics Co., Ltd., Suwon-si (KR)

(72) Inventors: Yanghee CHO, Suwon-si (KR); Sunghea CHO, Suwon-si (KR); Dohyun KIM, Suwon-si (KR); Jongcheun SEO, Suwon-si (KR); Junguk JUN, Suwon-si (KR); Namkyu CHO, Suwon-si (KR)

(21) Appl. No.: 18/358,408

(22) Filed: Jul. 25, 2023

Related U.S. Application Data
(63) Continuation of application No. PCT/KR2021/019952, filed on Dec. 27, 2021.

(30) Foreign Application Priority Data
Feb. 26, 2021 (KR) 10-2021-0026658

(51) Int. Cl. F04C 29/12; F04C 18/02

(52) U.S. Cl. CPC F04C 29/12; F04C 18/0215

(57) ABSTRACT

A scroll compressor is provided. The scroll compressor includes a fixed scroll having an outlet and multiple release holes, a release valve ring installed on the top surface of the fixed scroll and formed to open and close the multiple release holes, and a retainer ring installed on the release valve ring and formed to restrict the movement of the release valve ring. The release valve ring has a ring shape, and comprises a fixing part, multiple release valves, and at least one connection part. The retainer ring comprises a retainer fixing part, multiple retainers, and at least one retainer connection part connecting at least one of the multiple retainers to the retainer fixing part.

### CROSS-REFERENCE TO RELATED APPLICATION(S)

This application is a continuation application, claiming priority under § 365(c), of an International application No. PCT/KR2021/019952, filed on Dec. 27, 2021, which is based on and claims the benefit of a Korean patent application number 10-2021-0026658, filed on Feb. 26, 2021, in the Korean Intellectual Property Office, the disclosure of which is incorporated by reference herein in its entirety.

### BACKGROUND

### 1. Field

The disclosure relates to a scroll compressor. More particularly, the disclosure relates to a scroll compressor having a plurality of release valves.

### 2. Description of Related Art

A scroll compressor is a device that compresses refrigerant by engaging a fixed scroll and an orbiting scroll each having a spiral wrap and rotating the orbiting scroll relative to the fixed scroll.

The scroll compressor has a plurality of compression pockets formed by the fixed scroll fixed in a sealed casing and the orbiting scroll facing and orbiting relative to the fixed scroll. The plurality of compression pockets are gradually narrowed from the outer circumferential side of the fixed scroll toward the center thereof by the orbiting motion of the orbiting scroll. The refrigerant is sucked into the compression pocket located on the outer circumferential side, and is compressed while the compression pocket moves toward the center by the rotation of the orbiting scroll, so that when the compression pocket is located at the center, the maximum compressed refrigerant is discharged from the compression pocket into the sealed casing.

Recently, system air conditioners require improved performance of the air conditioner in partial load operation conditions.

To this end, the number of release valves is gradually increasing in scroll compressors. In this case, it is necessary to optimize the location and number of release valves to minimize an over-compression phenomenon under the condition of low pressure ratio.

However, when the number of release valves increases in the scroll compressor, there is a problem in that assembly performance deteriorates.

For example, when a plurality of release valves are individually assembled, a case in which a release valve and a retainer do not match may occur. In this case, the function of the scroll compressor may be deteriorated.

In addition, some release valves among the plurality of release valves may be missing during assembly.

Further, the structure in which the plurality of release valves and the plurality of retainers are separately assembled has a problem in that the maximum number of the plurality of release valves that can be disposed on the upper surface of the fixed scroll of the scroll compressor is limited.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a scroll compressor in which a plurality of release valves are integrally formed so as to improve the construction of the plurality of release valves in view of the above problems.

Additional aspects will be set forth in part in the description which follows and, in part, will be apparent from the description, or may be learned by practice of the presented embodiments.

In accordance with an aspect of the disclosure, a scroll compressor is provided. The scroll compressor includes a fixed scroll provided with a discharge port and a plurality of release holes, a release valve ring disposed on an upper surface of the fixed scroll and formed to open and close the plurality of release holes, and a retainer ring disposed on an upper side of the release valve ring and formed to limit movement of the release valve ring. The release valve ring includes a fixing part having a ring shape and including a plurality of fastening holes, a plurality of release valves extending from an inner circumferential surface of the fixing part toward a center of the fixing part and formed to open and close the plurality of release holes, and at least one connecting part formed to connect at least one release valve among the plurality of release valves and the inner circumferential surface of the fixing part. The retainer ring includes a retainer fixing part having a shape corresponding to the fixing part of the release valve ring, a plurality of retainers formed to limit upward movement of the plurality of release valves of the release valve ring, and at least one retainer connecting part corresponding to the at least one connecting part of the release valve ring and formed to connect at least one retainer among the plurality of retainers and the retainer fixing part.

Each of the plurality of release valves includes a head portion formed to open and close each of the plurality of release holes, and a neck portion extending from the head portion, connected to the fixing part or the at least one connecting part of the release valve ring, and having a narrower width than the head portion.

The at least one connecting part may have a width greater than the width of the neck portion of the release valve.

Each of the plurality of retainers includes a head portion corresponding to the head portion of each of the plurality of release valves, and a neck portion extending from the head portion, connected to the retainer fixing part or the at least one retainer connecting part of the retainer ring, and having a narrower width than the head portion.

The at least one retainer connecting part may have a width greater than the width of the neck portion of the retainer.

The plurality of retainers may be formed to be curved in a direction perpendicular to the upper surface of the fixed scroll. The at least one retainer connecting part may be formed on a same plane as the retainer fixing part.

The plurality of release valves may all have different lengths.

The retainer fixing part and the at least one retainer connecting part of the retainer ring may be formed in a same shape as the fixing part and the at least one connecting part of the release valve ring.

The scroll compressor includes a check valve disposed at a central portion of the release valve ring and the retainer ring to open and close the discharge port of the fixed scroll.

The discharge port may be formed inside an imaginary circle having a radius 0.3 times a radius of the upper surface of the fixed scroll from a center of the upper surface of the fixed scroll.

Each of the plurality of release holes may be formed as at least one through hole penetrating the upper surface of the fixed scroll.

The fixed scroll includes an upper plate having a disk shape, and a fixed wrap provided on a lower surface of the upper plate and formed in a curved surface having a curvature radius decreasing toward a center of the upper plate. The plurality of release holes may be formed along the fixed wrap.

Each of the plurality of release valves may be formed so that a center line in a longitudinal direction of the release valve is directed in a direction of a curvature radius of a curve corresponding to a portion of the fixed wrap adjacent to the release hole covered by the release valve.

The fixing part and the at least one connecting part of the release valve ring may be in contact with the upper surface of the fixed scroll, and the retainer fixing part and the at least one retainer connecting part of the retainer ring may be in contact with the upper surfaces of the fixing part and the at least one connecting part of the release valve ring.

The release valve ring includes at least nine release valves, and the retainer ring includes at least nine retainers.

In the scroll compressor according to an embodiment of the disclosure having the above structure, a plurality of release valves are integrated into a release valve ring, and a plurality of retainers are integrated into a retainer ring, so that the scroll compressor may be easier to be assembled than the scroll compressor according to the related art in which a plurality of release valves and a plurality of retainers are separately formed.

In addition, in the scroll compressor according to an embodiment of the disclosure, because a release valve ring including a plurality of release valves and a retainer ring including a plurality of retainers are disposed on the upper surface of the fixed scroll at once, assembly defects may be prevented or minimized.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a scroll compressor according to an embodiment of the disclosure;

FIG. 2 is a cross-sectional view illustrating the scroll compressor of FIG. 1 taken along line I-I according to an embodiment of the disclosure;

FIG. 3 is a cross-sectional view illustrating the scroll compressor of FIG. 1 taken along line II-II according to an embodiment of the disclosure;

FIG. 4 is an exploded perspective view illustrating the scroll compressor of FIG. 1 from which an upper casing is separated according to an embodiment of the disclosure;

FIG. 5 is a perspective view illustrating a fixed scroll assembly of a scroll compressor according to an embodiment of the disclosure;

FIG. 6 is a cross-sectional view illustrating the fixed scroll assembly of FIG. 5 taken along line III-III according to an embodiment of the disclosure;

FIG. 7 is an exploded perspective view illustrating the fixed scroll assembly of FIG. 5 according to an embodiment of the disclosure;

FIG. 8 is a plan view illustrating a fixed scroll of a scroll compressor according to an embodiment of the disclosure;

FIG. 9 is a bottom view illustrating a fixed scroll of a scroll compressor according to an embodiment of the disclosure;

FIG. 10 is a graph illustrating a relationship between a discharge region of a fixed scroll and a radius of curvature of a fixed wrap in a scroll compressor according to an embodiment of the disclosure;

FIG. 11 is a perspective view illustrating a state in which a release valve ring is disposed in a fixed scroll of a scroll compressor according to an embodiment of the disclosure;

FIG. 12 is a view for explaining a relationship between a fixed wrap of a fixed scroll and a plurality of release valves of a release valve ring in a scroll compressor according to an embodiment of the disclosure; and

FIG. 13 is a perspective view illustrating a state in which a release valve ring and a retainer ring are disposed in a fixed scroll of a scroll compressor according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms ‘first’, ‘second’, etc. may be used to describe diverse components, but the components are not limited by the terms. The terms may only be used to distinguish one component from the others. For example, without departing from the scope of the disclosure, a first component may be referred to as a second component, and similarly, a second component may also be referred to as a first component.

The terms used in embodiments of the disclosure may be construed as commonly known to those skilled in the art unless otherwise defined.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

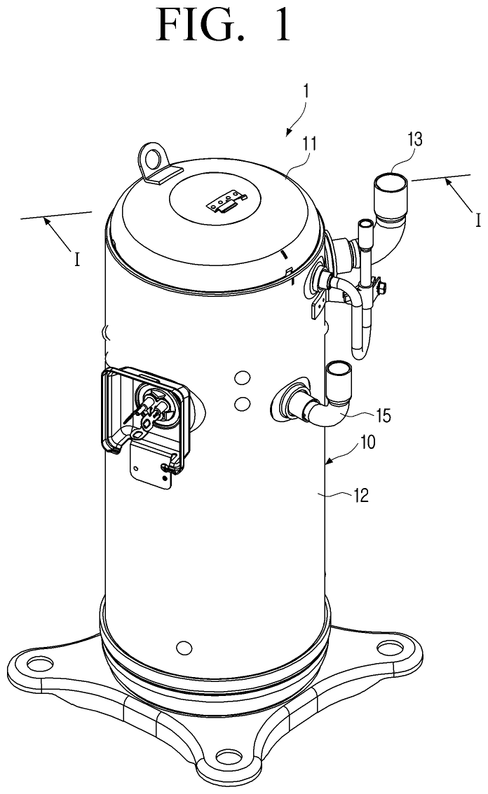

Hereinafter, a scroll compressor 1 according to an embodiment of the disclosure will be described in detail with reference to FIGS. 1 to 4.

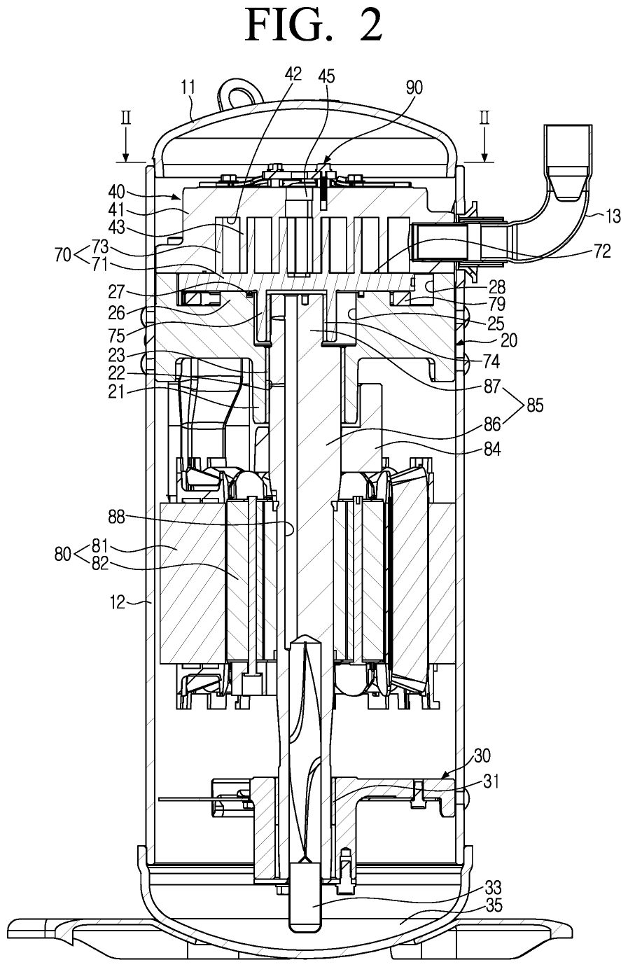

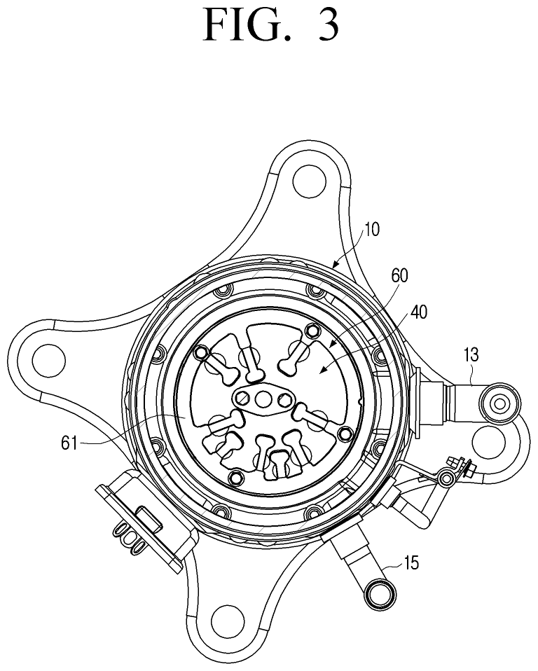

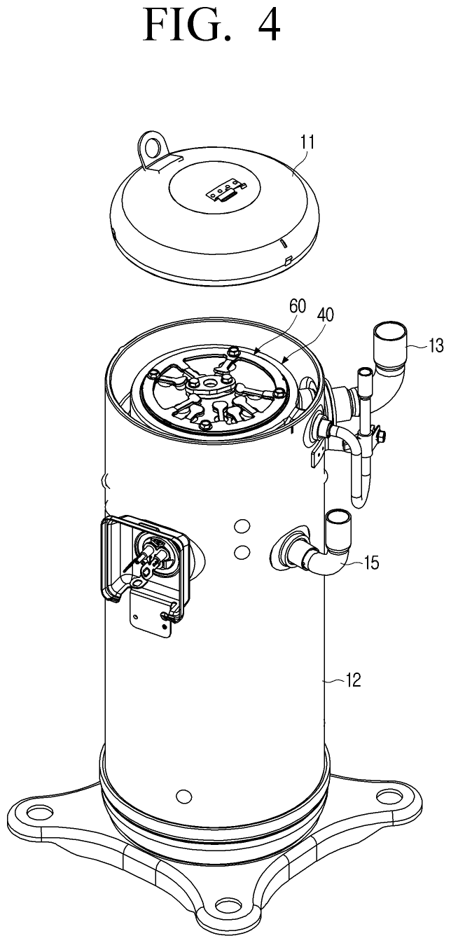

FIG. 1 is a perspective view illustrating a scroll compressor according to an embodiment of the disclosure. FIG. 2 is a cross-sectional view illustrating the scroll compressor of FIG. 1 taken along line I-I according to an embodiment of the disclosure. FIG. 3 is a cross-sectional view illustrating the scroll compressor of FIG. 1 taken along line II-II according to an embodiment of the disclosure. FIG. 4 is an exploded perspective view illustrating the scroll compressor of FIG. 1 from which an upper casing is separated according to an embodiment of the disclosure.

Referring to FIGS. 1 to 4, the scroll compressor 1 according to an embodiment of the disclosure may include a casing 10, a main frame 20, a sub frame 30, a fixed scroll 40, an orbiting scroll 70, and a drive motor 80.

The casing 10 is an airtight container having a cylindrical shape and may include an upper casing 11 and a lower casing 12. Inside the casing 10, the main frame 20, the sub frame 30, the fixed scroll 40, the orbiting scroll 70, and the drive motor 80 may be accommodated.

The casing 10 may be provided with a refrigerant inlet pipe 13 through which refrigerant is introduced and a refrigerant discharge pipe 15 through which refrigerant is discharged. The refrigerant inlet pipe 13 passes through the casing 10, and one end of the refrigerant inlet pipe 13 is connected to the fixed scroll 40. The refrigerant discharge pipe 15 passes through the casing 10, and one end of the refrigerant discharge pipe 15 may communicate with the inside of the casing 10. Therefore, refrigerant may flow into the fixed scroll 40 disposed in the casing 10 through the refrigerant inlet pipe 13 and may be discharged to the outside of the casing 10 through the refrigerant discharge pipe 15.

The main frame 20 and the sub frame 30 are fixed inside the casing 10 vertically by a predetermined distance. The drive motor 80 is rotatably disposed between the main frame 20 and the sub frame 30.

The fixed scroll 40 and the orbiting scroll 70 may be disposed above the main frame 20. An oil reservoir 35 storing oil or lubricating oil for lubricating and cooling parts accommodated in the casing 10 may be provided in the lower portion of the casing 10 below the sub frame 30.

The main frame 20 is formed in a substantially disc shape, and a projecting portion 21 may be formed on a lower surface of the main frame 20. A shaft support hole 22 is formed in the projecting portion 21 of the main frame 20, and a bearing metal 23 supporting a rotating shaft may be disposed in the shaft support hole 22. The rotating shaft 85 is inserted through the bearing metal 23, so that the bearing metal 23 may support rotation of the rotating shaft 85.

A boss insertion groove 25 having an inner diameter larger than the inner diameter of the shaft support hole 22 may be provided on the upper side of the shaft support hole 22.

An annular protrusion 26 forming a top end of the boss insertion groove 25 may be provided on the upper surface of the main frame 20. An upper surface of the annular protrusion 26 may be formed as a mirror surface that contacts and supports the orbiting scroll 70. In addition, an oil ring 27 may be disposed on the upper surface of the annular protrusion 26 to surround the boss insertion groove 25.

An annular groove 28 is provided outside the annular protrusion 26, and the annular groove 28 may form a back pressure chamber together with the orbiting scroll 70. Oil supplied from the oil reservoir 35 may be filled in the back pressure chamber.

In addition, an anti-rotation mechanism 79 for preventing the orbiting scroll 70 from self-rotation may be disposed in the back pressure chamber between the orbiting scroll 70 and the main frame 20. An Oldham ring may be used as the anti-rotation mechanism 79.

The fixed scroll 40 may be disposed on the upper side of the main frame 20, and the orbiting scroll 70 may be accommodated in a space formed by the fixed scroll 40 and the main frame 20.

The orbiting scroll 70 may be disposed between the fixed scroll 40 and the main frame 20 so that the orbiting scroll 70 engages with the fixed scroll 40 and performs orbital movement with respect to the fixed scroll 40.

The fixed scroll 40 may include a body portion 41 and a fixed wrap 43.

The body portion 41 is formed in a shape corresponding to the inner surface of the casing 10, and a fixed mirror surface 42 is formed on a surface facing the orbiting scroll 70. The fixed wrap 43 extends vertically from the fixed mirror surface 42 of the body portion 41 and may be formed as a curved surface having a predetermined thickness and height.

A discharge port 45 through which the refrigerant compressed by the fixed scroll 40 and the orbiting scroll 70 is discharged may be formed on the upper surface of the body portion 41, and an inlet 46 through which the refrigerant flows into may be formed on the side surface of the body portion 41. The inlet 46 may be connected to the refrigerant inlet pipe 13 disposed in the casing 10. Accordingly, the refrigerant introduced through the refrigerant inlet pipe 13 may be drawn into the fixed scroll 40 through the inlet 46.

A release valve ring 50 and a retainer ring 60 may be disposed on the upper surface of the fixed scroll 40. The fixed scroll 40, the release valve ring 50, and the retainer ring 60 may form a fixed scroll assembly. The fixed scroll assembly will be described in detail below.

The orbiting scroll 70 may include an orbiting plate 71, an orbiting wrap 73, and a boss portion 75.

The orbiting plate 71 may be formed in a disk shape having a predetermined thickness and area, and may include an orbiting mirror surface 72 formed on a surface of the orbiting plate 71 facing the fixed scroll 40.

The orbiting wrap 73 extends vertically from the orbiting mirror surface 72 of the orbiting plate 71 and may be formed as a curved surface having a predetermined thickness and height. For example, the orbiting wrap 73 may be formed as a curved surface in which an inner curve forming the inner surface of the orbiting wrap 73 and an outer curve forming the outer surface of the orbiting wrap 73 are formed as an involute curve, a hybrid curve, or the like. The orbiting wrap 73 may be formed to engage with the fixed wrap 43 of the fixed scroll 40.

The boss portion 75 may be formed in the center of the lower surface of the orbiting plate 71 opposite to the orbiting mirror surface 72. One end of the rotating shaft 85 may be inserted into the boss portion 75.

The orbiting wrap 73 of the orbiting scroll 70 may be engaged with the fixed wrap 43 of the fixed scroll 40, and the boss portion 75 may be inserted into the boss insertion groove 25 of the main frame 20. In addition, one surface of the orbiting plate 71 on which the boss portion 75 is formed may be supported by the mirror surface of the main frame 20. Accordingly, one surface of the orbiting plate 71 supported by the mirror surface of the main frame 20 may be formed as a mirror surface.

A plurality of compression pockets formed by the fixed wrap 43 of the fixed scroll 40 and the orbiting wrap 73 of the orbiting scroll 70 may form a compression chamber for compressing the refrigerant introduced into the inlet 46 of the fixed scroll 40.

The drive motor 80 may include a stator 81 and a rotor 82. The stator 81 may be fixed to the inner surface of the casing 10. The rotor 82 may be rotatably inserted inside the stator 81. In addition, the rotating shaft 85 may be inserted through the rotor 82. The rotor 82 is fixed to the rotating shaft 85 and may rotate integrally with the rotating shaft 85.

The rotating shaft 85 may include a shaft portion 86 formed to have a predetermined length and an eccentric portion 87 extending upward from one end of the shaft portion 86.

The rotor 82 of the drive motor 80 may be fixed to the shaft portion 86 of the rotating shaft 85. One end of the shaft portion 86 is inserted into the projecting portion 21 of the main frame 20, and may be supported by the bearing metal 23 disposed in the projecting portion 21.

One end of the rotating shaft 85, that is, the eccentric portion 87 may be inserted into the boss portion 75 of the orbiting scroll 70. A bearing metal 74 may be disposed between the eccentric portion 87 of the rotating shaft 85 and the boss portion 75 of the orbiting scroll 70.

A balance weight 84 may be disposed on the shaft portion 86 of the rotating shaft 85 above the rotor 82. The lower portion of the shaft portion 86 may be supported by a bearing metal 31 disposed in the sub frame 30.

In addition, an oil passage 88 formed to pass through the shaft portion 86 and the eccentric portion 87 may be formed in the rotating shaft 85. An oil supply device 33 for supplying oil from the oil reservoir 35 to the oil passage 88 may be disposed at a lower end of the rotating shaft 85.

One end of the oil supply device 33 may be submerged in the oil reservoir 35 of the casing 10. Therefore, when the rotating shaft 85 rotates, the oil stored in the oil reservoir 35 may be supplied to the oil passage 88 of the rotating shaft 85 by the pressure acting on the oil reservoir 35 and the oil supply device 33. The oil supplied to the oil passage 88 may be supplied to the boss portion 75 of the orbiting scroll 70 and the bearing metal 23 of the main frame 20.

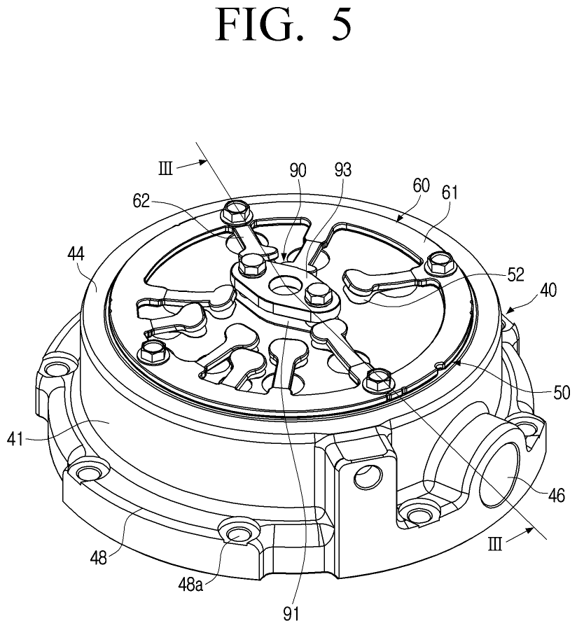

Hereinafter, the fixed scroll assembly of the scroll compressor 1 according to an embodiment of the disclosure will be described in detail with reference to FIGS. 5 to 9.

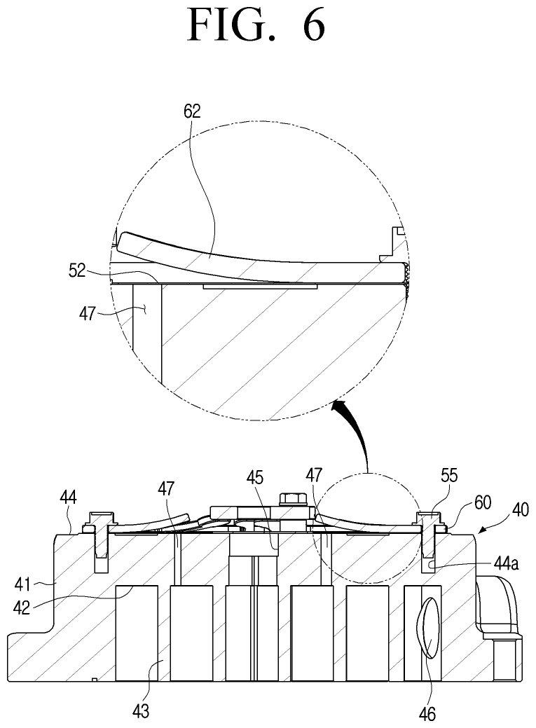

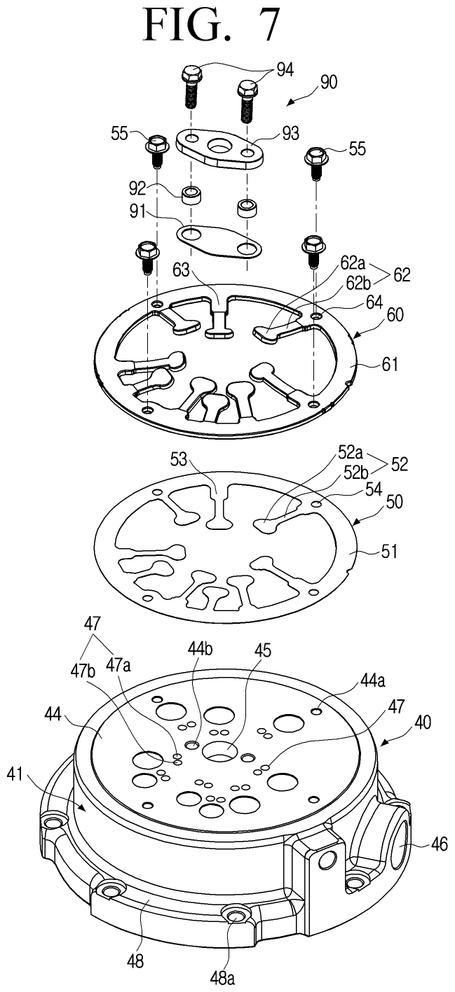

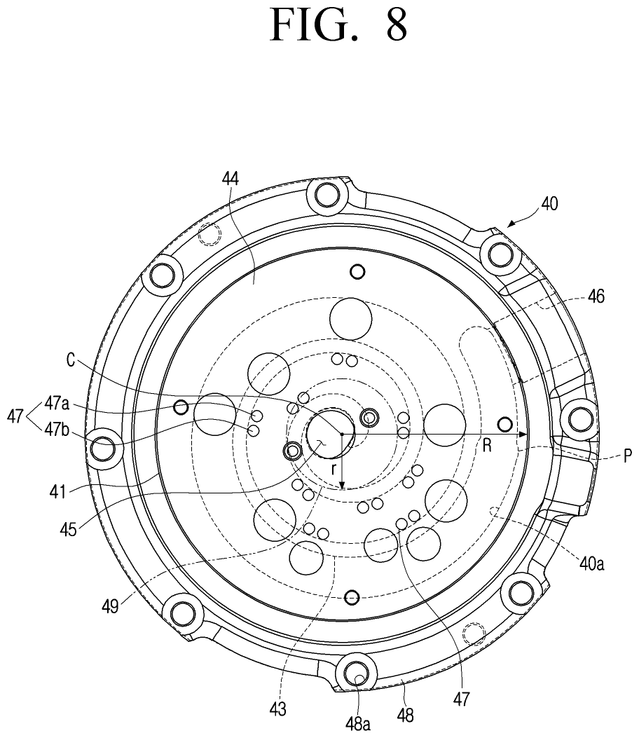

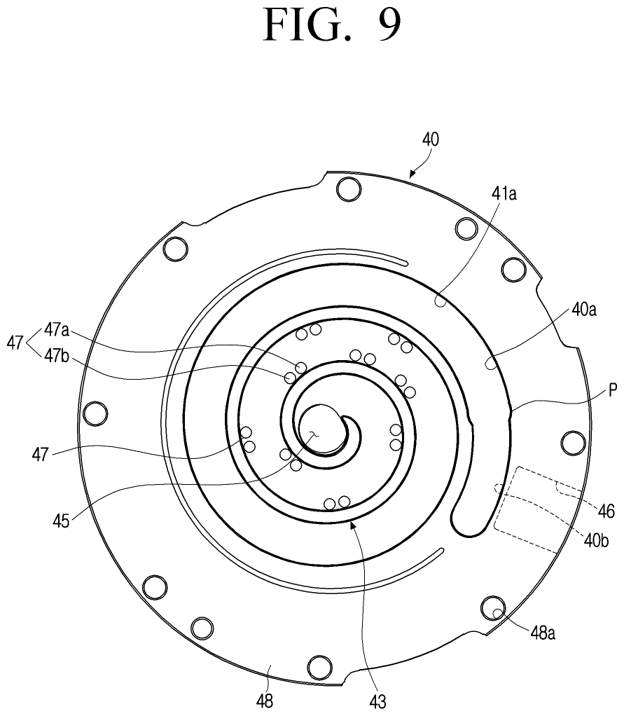

FIG. 5 is a perspective view illustrating a fixed scroll assembly of a scroll compressor according to an embodiment of the disclosure. FIG. 6 is a cross-sectional view illustrating the fixed scroll assembly of FIG. 5 taken along line III-III according to an embodiment of the disclosure. FIG. 7 is an exploded perspective view illustrating the fixed scroll assembly of FIG. 5 according to an embodiment of the disclosure. FIG. 8 is a plan view illustrating a fixed scroll of a scroll compressor according to an embodiment of the disclosure. FIG. 9 is a bottom view illustrating a fixed scroll of a scroll compressor according to an embodiment of the disclosure.

Referring to FIGS. 5 to 7, the fixed scroll assembly of the scroll compressor 1 according to an embodiment of the disclosure may include the fixed scroll 40, the release valve ring 50, and the retainer ring 60.

The fixed scroll 40 may include a body portion 41 and a fixed wrap 43 as described above.

The body portion 41 is accommodated inside the casing 10 and may be formed in a substantially hollow cylindrical shape. An upper plate 44 blocking the body portion 41 may be provided at the upper end of the body portion 41, and a flange 48 for fixing the main frame 20 may be provided at the lower end of the body portion 41.

A plurality of through holes 48a for coupling with the main frame 20 may be formed in the flange 48. Accordingly, the fixed scroll 40 may be fixed to the main frame 20 with a plurality of bolts inserted into the plurality of through holes 48a of the flange 48.

The upper plate 44 of the body portion 41 is formed in a disk shape, and may be provided with a discharge port 45 and a plurality of release holes 47 through which refrigerant is discharged. The fixed mirror surface 42 may be formed on the lower surface of the upper plate 44 facing the orbiting scroll 70.

The fixed wrap 43 extends vertically from the fixed mirror surface 42 of the body portion 41, and may be formed as a spiral-shaped curved surface having a predetermined thickness and height. For example, the fixed wrap 43 may be formed as a curved surface in which an inner curve forming the inner surface of the fixed wrap 43 and an outer curve forming the outer surface of the fixed wrap 43 are formed as an involute curve, a hybrid curve, or the like.

In addition, the fixed wrap 43 may be formed as a curved surface whose curvature continuously increases from the periphery of the body portion 41 of the fixed scroll 40 toward the center of the body portion 41. In other words, the fixed wrap 43 may be formed as a curved surface whose radius of curvature continuously decreases from the periphery of the body portion 41 of the fixed scroll 40 toward the center of the body portion 41.

The discharge port 45 may be formed in a central portion of the body portion 41 so as to pass through the upper plate 44 of the body portion 41. Here, the central portion of the body portion 41 may refer to the inside of an imaginary circle 49 having a predetermined radius r from the center C of the upper surface of the body portion 41. The central portion of the body portion 41 may have a smaller radius r than the radius R of the upper surface of the body portion 41.

For example, as illustrated in FIGS. 8 and 9, the inner area of an imaginary circle 49 having a radius r of 0.3 times the radius R of the upper surface of the fixed scroll 40, that is, the upper surface of the body portion 41, from the center C of the upper surface of the fixed scroll 40 may be defined as the central portion of the body portion 41. In this case, the discharge port 45 may be formed inside the central portion of the body portion 41. In other words, the discharge port 45 may be formed within the imaginary circle 49 having a radius (r=0.3 R) 0.3 times the radius R of the upper surface of the fixed scroll 40 from the center C of the upper surface of the fixed scroll 40.

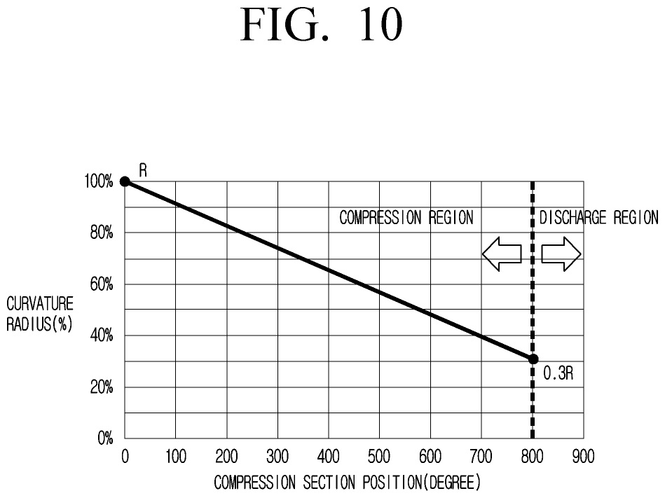

FIG. 10 is a graph illustrating a relationship between a discharge region of a fixed scroll and a radius of curvature of a fixed wrap in a scroll compressor according to an embodiment of the disclosure.

Referring to FIG. 10, the vertical axis represents the radius of curvature of the compression section, and the horizontal axis represents the position of the compression section. In FIG. 10, when the radius of curvature is 100%, it represents the radius R of the upper surface of the fixed scroll 40, and the radius of curvature decreases as the position of the compression section 40a moves toward the center.

Referring to FIG. 10, the range from a starting point P of the compression section 40a to about 800 degrees is a compression range where the refrigerant is compressed, and the range from 800 degrees to 900 degrees is a discharge region where the compressed refrigerant is discharged through the discharge port 45. In other words, the discharge region refers to the inner area of the imaginary circle 49 having a radius (0.3 R) 0.3 times the radius R of the upper surface of the fixed scroll 40 from the center C of the upper surface of the fixed scroll 40. For example, when the radius of the upper surface of the fixed scroll 40 is R, the discharge region refers to the inner area of the imaginary circle 49 having a radius r of 0.3 R. The compression region refers to an area excluding the discharge region from the inside of the circle having a radius of R.

Referring to FIGS. 8 and 9, the compression section 40a refers to the inner surface of the fixed scroll 40 forming a plurality of compression pockets together with the orbiting wrap 73 of the orbiting scroll 70. The compression section 40a may be formed by the inner circumferential surface 41a of the body portion 41 and the fixed wrap 43. Accordingly, the compression section 40a may be formed as a spiral-shaped curved surface having a radius of curvature that decreases toward the center C of the body portion 41 of the fixed scroll 40, that is, a curvature that increases toward the center C of the body portion 41. The starting point P of the compression section 40a refers to a place where the radius from the center C of the body portion 41 is the largest in the inner circumferential surface 41a of the body portion 41 of the fixed scroll 40.

A suction section 40b connected to the inlet 46 may be provided at the leading end of the compression section 40a, that is, at the starting point P of the compression section 40a. Accordingly, the refrigerant drawn into the inlet 46 may flow into the compression section 40a through the suction section 40b. The refrigerant flowing into the compression section 40a may be compressed by the fixed wrap 43 of the fixed scroll 40 and the orbiting wrap 73 of the orbiting scroll 70 while moving to the discharge port 45 and discharged through the discharge port 45 to the outside of the fixed scroll 40.

As illustrated in FIG. 5, a check valve 90 configured to selectively open and close the discharge port 45 may be disposed on the upper surface of the fixed scroll 40. The check valve 90 may be disposed in the discharge region of the fixed scroll 40. In other words, when the radius of the upper surface of the fixed scroll 40 is R, the check valve 90 may be disposed to open and close the discharge port 45 provided inside the imaginary circle 49 having a radius of 0.3 R from the center C of the fixed scroll 40.

Therefore, the refrigerant compressed by the compression chamber formed by the fixed wrap 43 of the fixed scroll 40 and the orbiting wrap 73 of the orbiting scroll 70 may be discharged to the outside of the fixed scroll 40, that is, to the inside of the casing 10 through the discharge port 45 and the check valve 90.

Referring to FIGS. 5 to 7, the check valve 90 may include a valve sheet 91 that opens and closes the discharge port 45, a check valve guide 92 that is provided on the upper surface of the fixed scroll 40 and guides vertical movement of the valve sheet 91, a check valve stopper 93 formed to limit the movement of the valve sheet 91, and a fastening member 94 for fixing the check valve guide 92 and the check valve stopper 93 to the upper surface of the fixed scroll 40.

The fastening member 94 may include two bolts, and the two bolts may be fastened to two screw grooves 44b formed on the upper surface of the fixed scroll 40. The two check valve guides 92 and the check valve stopper 93 are fixed to the upper surface of the fixed scroll 40 by two bolts.

Therefore, the valve sheet 91 may move up and down along the two check valve guides 92, and may be interfered with by the fixed scroll 40 in the downward direction and interfered with by the check valve stopper 93 in the upward direction so that the movement of the valve sheet 91 is restricted.

When the refrigerant is compressed and the pressure of the discharge port 45 of the fixed scroll 40 is higher than the pressure inside the casing 10, the compressed refrigerant in the discharge port 45 may push the valve sheet 91 upward and may be discharged into the casing 10.

When the pressure of the refrigerant in the discharge port 45 is lower than the pressure inside the casing 10, the valve sheet 91 blocks the discharge port 45 to prevent the refrigerant inside the casing 10 from flowing backward into the discharge port 45. In other words, the check valve 90 may allow the refrigerant to flow from the inside of the fixed scroll 40 to the inside of the casing 10 in only one direction.

A plurality of release holes 47 are provided to improve the performance of the air conditioner when the air conditioner operates under partial load operation conditions. The location and number of the plurality of release holes 47 may be determined to minimize an over-compression phenomenon in the partial load operation conditions with a low pressure ratio. The refrigerant compressed by the fixed scroll 40 and the orbiting scroll 70 may be discharged into the casing 10 through the plurality of release holes 47 of the fixed scroll 40.

The plurality of release holes 47 may be formed to pass through the upper plate 44 of the fixed scroll 40. The plurality of release holes 47 may be formed along the fixed wrap 43. The pressure of the refrigerant discharged through the release hole 47 formed adjacent to the center of the fixed scroll 40 may be higher than the pressure of the refrigerant discharged through the release hole 47 formed far from the center of the fixed scroll 40.

Each of the plurality of release holes 47 may be formed adjacent to the fixed wrap 43. The plurality of release holes 47 may be formed such that the center of each of the release holes 47 is spaced apart from the surface of the fixed wrap 43 by a predetermined distance. The plurality of release holes 47 may be formed to have the same diameter. All of the plurality of release holes 47 may be formed to be spaced the same distance from the surface of the fixed wrap 43. The plurality of release holes 47 may be formed at positions that do not interfere with the fixed wrap 43.

Each of the plurality of release holes 47 may be formed as one through hole penetrating the upper plate 44 of the fixed scroll 40. As another example, each of the plurality of release holes 47 may be formed as two or more through holes penetrating the upper plate 44 of the fixed scroll 40. In other words, each of the plurality of release holes 47 may be formed as at least one through hole penetrating the upper plate 44 of the fixed scroll 40.

As illustrated in FIGS. 8 and 9, each of the plurality of release holes 47 of the fixed scroll 40 according to this embodiment is formed with two through holes 47a and 47b.

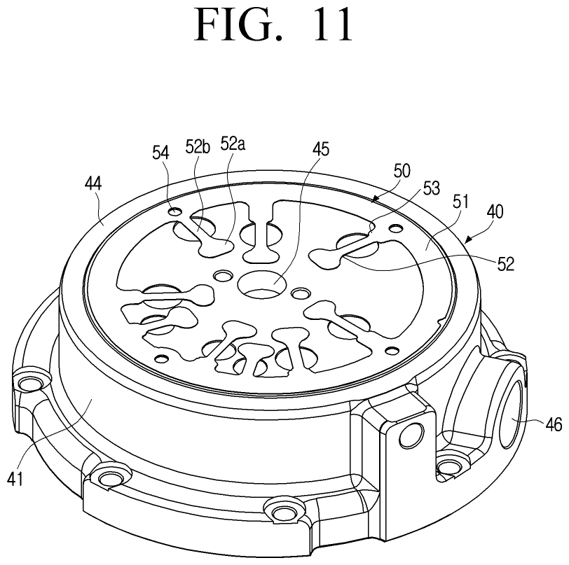

FIG. 11 is a perspective view illustrating a state in which a release valve ring is disposed in a fixed scroll of a scroll compressor according to an embodiment of the disclosure.

Referring to FIG. 11, the release valve ring 50 is disposed on the upper surface of the fixed scroll 40 and may be formed to open and close the plurality of release holes 47.

The release valve ring 50 may include a fixing part 51, a plurality of release valves 52, and at least one connecting part 53.

The fixing part 51 has a ring shape and may include a plurality of fastening holes 54. For example, the fixing part 51 may be formed in a ring shape corresponding to the upper plate 44 of the fixed scroll 40. The fixing part 51 may be formed to have an outer diameter smaller than the diameter of the upper plate 44 of the fixed scroll 40.

The fixing part 51 may be formed to have a predetermined width that does not cover the release holes 47. In addition, the width of the fixing part 51 may be determined so that the release valves 52 extending directly from the inner circumferential surface of the fixing part 51 without the connecting part 53 may open and close the release holes 47.

The fixing part 51 may be provided with a plurality of fastening holes 54 into which screws or bolts 55 are inserted so as to fix the release valve ring 50 to the upper surface of the fixed scroll 40. A plurality of screw grooves 44a into which a plurality of screws or bolts 55 are fastened may be provided on the upper surface of the fixed scroll 40.

In this embodiment, four fastening holes 54 are provided in the fixing part 51. However, the number of the plurality of fastening holes 54 is not limited thereto. For example, three or five or more fastening holes 54 may be formed.

The plurality of release valves 52 extend from the inner circumferential surface of the fixing part 51 toward the center thereof, and are formed to open and close the plurality of release holes 47 provided in the fixed scroll 40. Accordingly, the plurality of release valves 52 may be provided to correspond to the number of the plurality of release holes 47.

For example, in this embodiment, because nine release holes 47 are formed in the fixed scroll 40, the release valve ring 50 includes nine release valves 52. However, the number of release holes 47 formed in the fixed scroll 40 is not limited thereto. Ten or more release holes 47 may be formed.

The plurality of release valves 52 are formed to have different lengths. The distances from the outer circumferential surface of the body portion 41 of the fixed scroll 40 to the plurality of release holes 47 are all different, so that the plurality of release valves 52 may be formed to have different lengths.

Each of the plurality of release valves 52 may include a head portion 52a and a neck portion 52b. The head portions 52a of the plurality of release valves 52 may be formed to cover the plurality of release holes 47, respectively. The head portion 52a may be formed in various shapes. For example, the head portion 52a may be formed in an oval shape.

Because the plurality of release holes 47 formed in the fixed scroll 40 are formed in the same shape, the head portions 52a of the plurality of release valves 52 may be formed in the same shape.

The neck portion 52b of each of the plurality of release valves 52 extends vertically from the head portion 52a and may have a narrower width than the width of the head portion 52a. One end of the neck portion 52b may be connected to the fixing part 51 of the release valve ring 50 or to at least one connecting part 53.

The length of the neck portion 52b of the release valve 52 may be determined according to the pressure of the refrigerant discharged through the corresponding release hole 47. For example, a first release valve 52-1 that opens and closes a first release hole 47-1 may be formed to discharge the refrigerant through the first release hole 47-1 when the refrigerant reaches a first pressure. A second release valve 52-2 that opens and closes a second release hole 47-2 may be formed to discharge the refrigerant through the second release hole 47-2 when the refrigerant reaches a second pressure. Third to ninth release valves 52 may be formed to discharge the refrigerant through third to ninth release holes 47 when the refrigerant reaches third to ninth pressures. In this case, the first to ninth pressures of the refrigerant may all be different.

The length and width of the neck portion 52b of each of the release valves 52 may be determined to correspond to the pressure of the refrigerant to be discharged through each of the release holes 47. Accordingly, the lengths of the neck portions 52b of the plurality of release valves 52 may all be different.

The plurality of release valves 52 may be formed of a thin metal sheet having elasticity.

At least one connecting part 53 may be formed to connect at least one release valve 52 among the plurality of release valves 52 and the fixing part 51. The connecting part 53 serves to fix the release valve 52 like the fixing part 51.

In other words, the connecting part 53 may connect the release valve 52 spaced apart from the inner circumferential surface of the fixing part 51 to the inner circumferential surface of the fixing part 51. The length of the neck portion 52b of the release valve 52 is determined by the pressure of the refrigerant discharged through the release hole 47 covered by the release valve 52. Therefore, when the length of the neck portion 52b is shorter than the distance from the inner circumferential surface of the fixing part 51 to the release hole 47, the connecting part 53 may be provided between one end of the neck portion 52b and the inner circumferential surface of the fixing part 51.

The connecting part 53 may be formed to have a larger width than the width of the neck portion 52b of the release valve 52.

Accordingly, the release valve 52 may be formed to directly extend from the inner circumferential surface of the fixing part 51 according to the pressure of the refrigerant discharged through the plurality of release holes 47. In other words, some of the release valves 52 may be directly connected to the inner circumferential surface of the fixing part 51 without the connecting part 53.

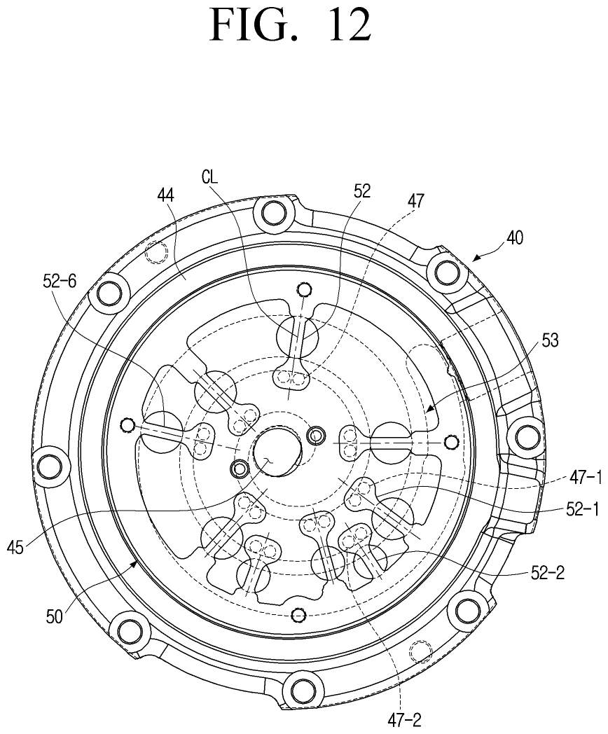

In the case of the release valve ring 50 of this embodiment illustrated in FIG. 12, the two release valves 52-2 and 52-6 extend directly from the inner circumferential surface of the fixing part 51, and the seven release valves 52 are connected to the inner circumferential surface of the fixing part 51 by the connecting parts 53.

FIG. 12 is a view for explaining a relationship between a fixed wrap of a fixed scroll and a plurality of release valves of a release valve ring in a scroll compressor according to an embodiment of the disclosure.

Referring to FIG. 12, each of the plurality of release valves 52 may be formed so that the center line (CL) of the release valve 52 in the longitudinal direction orients the radial direction of curvature of the fixed wrap 43. In detail, the release valve 52 may be formed so that the center line CL in the longitudinal direction of the release valve 52 is directed in the direction of the curvature radius of a curve corresponding to a portion of the fixed wrap 43 adjacent to the release hole 47 covered by the release valve 52.

In this way, when the plurality of release valves 52 are formed on the inner circumferential surface of the ring-shaped fixing part 51, the number of release valves 52 disposed on the upper surface of the fixed scroll 40 may be increased.

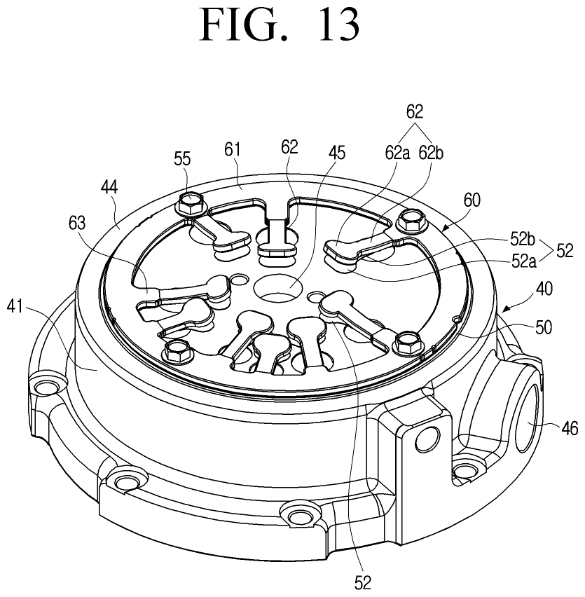

FIG. 13 is a perspective view illustrating a state in which a release valve ring and a retainer ring are disposed in a fixed scroll of a scroll compressor according to an embodiment of the disclosure.

Referring to FIG. 13, the retainer ring 60 may be disposed on the upper side of the release valve ring 50 disposed on the upper surface of the fixed scroll 40. The retainer ring 60 may be formed to limit upward movement of the release valve ring 50.

The retainer ring 60 may include a retainer fixing part 61, a plurality of retainers 62, and at least one retainer connecting part 63.

The retainer fixing part 61 may be formed to have a shape corresponding to the fixing part 51 of the release valve ring 50. In detail, the retainer fixing part 61 may have a ring shape and include a plurality of fastening holes 64. For example, the retainer fixing part 61 may be formed in a ring shape corresponding to the fixing part 51 of the release valve ring 50.

The outer diameter of the retainer fixing part 61 may be the same as the outer diameter of the fixing part 51 of the release valve ring 50, and may be smaller than the diameter of the upper plate 44 of the fixed scroll 40. The retainer fixing part 61 may be formed to have a predetermined width that does not cover the plurality of release holes 47.

In addition, the retainer fixing part 61 may be provided with a plurality of fixing holes 64 into which screws or bolts 55 are inserted so that the retainer ring 60 and the release valve ring 50 are fixed to the upper surface of the fixed scroll 40. The plurality of fixing holes 64 may be provided at positions corresponding to the plurality of fastening holes 54 of the fixing part 51 of the release valve ring 50. Accordingly, the retainer ring 60 and the release valve ring 50 may be fixed to the upper surface of the fixed scroll 40 at once with the plurality of bolts 55.

In this embodiment, four fixing holes 64 are provided in the retainer fixing part 61. However, the number of the plurality of fixing holes 64 is not limited thereto. For example, three or five or more fixing holes 64 may be formed.

The plurality of retainers 62 extend from the inner circumferential surface of the retainer fixing part 61 toward the center thereof, and are formed to limit upward movement of the plurality of release valves 52 of the release valve ring 50. Accordingly, the plurality of retainers 62 may be provided in numbers corresponding to the plurality of release valves 52 of the release valve ring 50.

For example, in this embodiment, because nine release holes 47 are formed in the fixed scroll 40 and the release valve ring 50 includes nine release valves 52, the retainer ring 60 includes nine retainers 62. However, the number of retainers 62 disposed in the fixed scroll 40 is not limited thereto. Ten or more retainers 62 may be provided according to the number of release holes 47 and release valves 52.

Each of the plurality of retainers 62 may be formed to be curved in a direction perpendicular to the upper surface of the fixed scroll 40 (see FIG. 6). Therefore, the plurality of retainers 62 are spaced apart from the plurality of release valves 52 disposed on the upper surface of the fixed scroll 40. In other words, the plurality of retainers 62 are disposed so as not to come into contact with the plurality of release valves 52.

The curvature at which the retainer 62 is curved may be determined according to the movement distance of the corresponding release valve 52. Therefore, when the release valve 52 is opened to the maximum by the refrigerant, the entire upper surface of the release valve 52 may come into contact with the lower surface of the retainer 62. When the release valve 52 blocks the release hole 47 of the fixed scroll 40, the release valve 52 is separated from the retainer 62.

Because the pressures of the refrigerants discharged through the plurality of release holes 47 of the fixed scroll 40 are different, the moving distances of the plurality of release valves 52 opening and closing the plurality of release holes 47 may be different. Accordingly, the curvatures of the plurality of retainers 62 that limit the moving distances of the plurality of release valves 52 may be different.

The plurality of retainers 62 may have different lengths. Because the lengths of the plurality of release valves 52 disposed on the upper surface of the body portion 41 of the fixed scroll 40 are all different, the plurality of retainers 62 may be formed to have different lengths.

Each of the plurality of retainers 62 may include a head portion 62a and a neck portion 62b. The head portions 62a of the plurality of retainers 62 may be formed to correspond to the head portions 52a of the plurality of release valves 52, respectively. In other words, the head portion 62a of the retainer 62 may be formed to have the same size and shape as the corresponding head portion 52a of the release valve 52. For example, when the head portion 52a of the release valve 52 is formed in an elliptical shape as this embodiment, the head portion 62a of the retainer 62 may be formed in an elliptical shape.

In addition, because the plurality of release valves 52 disposed on the fixed scroll 40 have the same head portion 52a, the head portions 62a of the plurality of retainers 62 may be formed in the same shape.

The neck portion 62b of each of the plurality of retainers 62 may be formed to correspond to the neck portion 52b of each of the plurality of release valves 52. In detail, the neck portion 62b of each of the plurality of retainers 62 extends vertically from the head portion 62a and may have a narrower width than the width of the head portion 62a. One end of the neck portion 62b may be connected to the inner circumferential surface of the retainer fixing part 61 of the retainer ring 60 or to at least one retainer connecting part 63.

The at least one retainer connecting part 63 corresponds to the at least one connecting part 53 of the release valve ring 50, and may be formed to connect at least one retainer 62 among the plurality of retainers 62 and the retainer fixing part 61. The retainer connecting part 63 serves to fix the retainer 62 like the retainer fixing part 61. To this end, the at least one retainer connecting part 63 may be formed on the same plane as the retainer fixing part 61.

In other words, the retainer connecting part 63 may connect the retainer 62 spaced apart from the inner circumferential surface of the retainer fixing part 61 to the inner circumferential surface of the retainer fixing part 61. The retainer connecting part 63 may be formed to have a larger width than the width of the neck portion 62b of the retainer 62.

Accordingly, when the release valve 52 is formed to directly extend from the inner circumferential surface of the fixing part 51, the corresponding retainer 62 may be formed to directly extend from the inner circumferential surface of the retainer fixing part 61. In other words, some of the retainers 62 may be directly connected to the inner circumferential surface of the retainer fixing part 61 without the retainer connecting part 63.

In addition, the retainer fixing part 61 and the at least one retainer connecting part 63 of the retainer ring 60 may be formed to have the same shape and size as the fixing part 51 and the at least one connecting part 53 of the release valve ring 50.

Therefore, as illustrated in FIG. 11, when the release valve ring 50 is disposed on the upper surface of the fixed scroll 40, the fixing part 51 and the at least one connecting part 53 of the release valve ring 50 are in close contact with the upper surface of the fixed scroll 40. In addition, as illustrated in FIG. 13, when the retainer ring 60 is disposed on the upper side of the release valve ring 50, the retainer fixing part 61 and the at least one retainer connecting part 63 of the retainer ring 60 are in close contact with the upper surfaces of the fixing part 51 and the at least one connecting part 53 of the release valve ring 50.

At this time, as illustrated in FIG. 5, the check valve 90 may be disposed in the central portion of the inner space of the release valve ring 50 and the retainer ring 60 disposed on the upper surface of the fixed scroll 40 to open and close the discharge port 45 of the fixed scroll 40.

In the scroll compressor 1 according to an embodiment of the disclosure having the above structure, the plurality of release valves 52 are integrated into the release valve ring 50, and the plurality of retainers 62 are integrated into the retainer ring 60, so that the scroll compressor 1 may be easier to be assembled than the scroll compressor according to the related art in which a plurality of release valves and a plurality of retainers are separately formed.

In addition, in the scroll compressor 1 according to an embodiment of the disclosure, because the release valve ring 50 including a plurality of release valves 52 and the retainer ring 60 including a plurality of retainers 62 may be disposed on the upper surface of the fixed scroll 40 at once, when assembling the fixed scroll assembly, assembly defects may be prevented from occurring.

In addition, because the scroll compressor 1 according to an embodiment of the disclosure having the above structure are provided with the release valve ring 50 including the plurality of release valves 52 and the retainer ring 60 for limiting upward movement of the plurality of release valves 52, the performance of air conditioner operating in partial load operation conditions may be improved.

In other words, when the air conditioner operates under a partial load operation condition, the refrigerant may be discharged into the casing 10 through the release valve 52 covering the release hole 47 through which the refrigerant at a pressure corresponding to the partial load operation condition is discharged among the plurality of release valves 52 of the scroll compressor 1. The refrigerant discharged into the casing 10 may be discharged to the outside of the scroll compressor 1 through the refrigerant discharge pipe 15.

In particular, because the scroll compressor 1 according to an embodiment of the disclosure includes nine release valves 52, the performance of the air conditioner may be improved in various partial load operation conditions compared to the scroll compressor according to the related art having six or less release valves 52.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A scroll compressor comprising:
a fixed scroll provided with a discharge port and a plurality of release holes;
a release valve ring disposed on an upper surface of the fixed scroll and formed to open and close the plurality of release holes; and
a retainer ring disposed on an upper side of the release valve ring and formed to limit movement of the release valve ring,
wherein the release valve ring comprises:
a fixing part having a ring shape and including a plurality of fastening holes,
a plurality of release valves extending from an inner circumferential surface of the fixing part toward a center of the fixing part and formed to open and close the plurality of release holes, and
at least one connecting part formed to connect at least one release valve among the plurality of release valves and the inner circumferential surface of the fixing part, and
wherein the retainer ring comprises:
a retainer fixing part having a shape corresponding to the fixing part of the release valve ring,
a plurality of retainers formed to limit upward movement of the plurality of release valves of the release valve ring, and
at least one retainer connecting part corresponding to the at least one connecting part of the release valve ring and formed to connect at least one retainer among the plurality of retainers and the retainer fixing part.

2. The scroll compressor of claim 1, wherein each of the plurality of release valves comprises:
a head portion formed to open and close each of the plurality of release holes; and
a neck portion extending from the head portion, connected to the fixing part or the at least one connecting part of the release valve ring, and having a narrower width than the head portion.

3. The scroll compressor of claim 2, wherein the at least one connecting part has a width greater than the width of the neck portion of the release valve.

4. The scroll compressor of claim 2, wherein each of the plurality of retainers comprises:
a head portion corresponding to the head portion of each of the plurality of release valves; and
a neck portion extending from the head portion, connected to the retainer fixing part or the at least one retainer connecting part of the retainer ring, and having a narrower width than the head portion.

5. The scroll compressor of claim 4, wherein the at least one retainer connecting part has a width greater than the width of the neck portion of the retainer.

6. The scroll compressor of claim 1,
wherein the plurality of retainers are formed to be curved in a direction perpendicular to the upper surface of the fixed scroll, and
wherein the at least one retainer connecting part is formed on a same plane as the retainer fixing part.

7. The scroll compressor of claim 1, wherein the plurality of release valves all have different lengths.

8. The scroll compressor of claim 1, wherein the retainer fixing part and the at least one retainer connecting part of the retainer ring are formed in a same shape as the fixing part and the at least one connecting part of the release valve ring.

9. The scroll compressor of claim 1, further comprising:
a check valve disposed at a central portion of the release valve ring and the retainer ring to open and close the discharge port of the fixed scroll.

10. The scroll compressor of claim 9, wherein the discharge port is formed inside an imaginary circle having a radius 0.3 times a radius of the upper surface of the fixed scroll from a center of the upper surface of the fixed scroll.

11. The scroll compressor of claim 1, wherein each of the plurality of release holes is formed as at least one through hole penetrating the upper surface of the fixed scroll.

12. The scroll compressor of claim 1,
wherein the fixed scroll comprises:
an upper plate having a disk shape, and
a fixed wrap provided on a lower surface of the upper plate and formed in a curved surface having a curvature radius decreasing toward a center of the upper plate, and
wherein the plurality of release holes are formed along the fixed wrap.

13. The scroll compressor of claim 12, wherein each of the plurality of release valves is formed so that a center line in a longitudinal direction of the release valve is directed in a direction of a curvature radius of a curve corresponding to a portion of the fixed wrap adjacent to the release hole covered by the release valve.

14. The scroll compressor of claim 1,
wherein the fixing part and the at least one connecting part of the release valve ring are in contact with the upper surface of the fixed scroll, and
wherein the retainer fixing part and the at least one retainer connecting part of the retainer ring are in contact with the upper surfaces of the fixing part and the at least one connecting part of the release valve ring.

15. The scroll compressor of claim 1,
wherein the release valve ring comprises at least nine release valves. and
wherein the retainer ring comprises at least nine retainers.
